(19) United States
(12) Patent Application Publication
(10) Pub. No.: US 2026/0169928 A1
(43) Pub. Date: Jun. 18, 2026

(54) CONFIDENTIAL COMPUTING GUEST PRIVATE PAGE

(71) Applicants: Advanced Micro Devices, Inc., Santa Clara, CA (US); ATI Technologies ULC, Markham (CA)

(72) Inventors: Anthony Asaro, Markham (CA); Nippon Raval, Markham (CA); Vidyashankar Viswanathan, Boxborough, MA (US)

(73) Assignees: Advanced Micro Devices, Inc., Santa Clara, CA (US); ATI Technologies ULC, Markham (CA)

(21) Appl. No.: 18/984,803

(22) Filed: Dec. 17, 2024

(51) Int. Cl. G06F 12/14

(52) U.S. Cl. CPC G06F 12/1408; G06F 12/1441; G06F 12/1475

(57) ABSTRACT

The disclosed circuit can select a key index in response to a memory request including a physical address. The physical address points to a location of a graphics processing unit memory that is encrypted. The circuit can forward the selected key index with the physical address to a memory controller of the graphics processing unit memory. The memory controller can complete the memory request using a key associated with the key index. Various other methods, systems, and computer-readable media are also disclosed.

### BACKGROUND

Computing devices, such as servers, often use virtual machines (VMs) to allow different computing contexts to use the computing devices'resources. Hypervisors can manage the virtual machines (e.g., guests) to maintain separation between guests. Confidential computing allows guest data to remain confidential (e.g., from other guests as well as from a hypervisor) to maintain guest data integrity even if the underlying hardware is shared between guests. However, such confidential computing mechanisms are often restricted such that certain hardware, such as a graphics processing unit (GPU) having its own processor and memory, are not available for confidential computing.

### BRIEF DESCRIPTION OF THE DRAWINGS

The accompanying drawings illustrate a number of exemplary implementations and are a part of the specification. Together with the following description, these drawings demonstrate and explain various principles of the present disclosure.

FIG. 1 is a block diagram of an exemplary system for confidential computing guest private pages.

FIG. 2 is a block diagram of an exemplary graphics processing unit (GPU) memory architecture.

FIG. 3 is a block diagram of various tables for key indexing.

FIG. 4 is a block diagram of a memory request pipeline for an exemplary graphics processing unit (GPU) memory architecture.

FIG. 5 is a diagram of an example address with a key index.

FIG. 6 is a flow diagram of an exemplary method for confidential computing using guest private pages.

Throughout the drawings, identical reference characters and descriptions indicate similar, but not necessarily identical, elements. While the exemplary implementations described herein are susceptible to various modifications and alternative forms, specific implementations have been shown by way of example in the drawings and will be described in detail herein. However, the exemplary implementations described herein are not intended to be limited to the particular forms disclosed. Rather, the present disclosure covers all modifications, equivalents, and alternatives falling within the scope of the appended claims.

### DETAILED DESCRIPTION

The present disclosure is generally directed to guest private pages for confidential computing incorporating GPU memory. Guest private pages provide a mechanism for keeping data stored in GPU memory to be confidential from other guests, as well as a hypervisor. Incorporating guest private pages in GPU memory can require guarantees that only a guest owning a private page can access (e.g., read and/or write) the private page. Each private page can be encrypted using keys unique to each guest such that only the guest with the corresponding key can encrypt/decrypt the page. However, identifying which keys are associated with each guest can introduce complexity in each memory request.

As will be explained in greater detail below, implementations of the present disclosure select and forward a key index along with a memory request to a memory controller of a GPU memory. The memory controller can encrypt/decrypt a physical address indicated in the memory request using a key indicated by the key index. The memory request can previously (e.g., during an address translation phase) be validated for a guest identifier that is a source of the memory request, such that a valid key index and key can be used. Accordingly, the systems and methods described herein incorporate key management in a memory request pipeline without incurring significant overhead. Thus, the systems and methods described herein advantageously provide confidential computing for guest data on a GPU memory.

In one implementation, a device for guest private pages for confidential computing with GPU memory includes a control circuit configured to select a key index in response to a memory request including a physical address, wherein the physical address corresponds to a location of a graphics processing unit memory that is encrypted, and forward the selected key index with the physical address to a memory controller of the graphics processing unit memory for completing the memory request.

In some examples, the memory controller is configured to identify a key using the key index, and perform an encryption operation on the physical address using the key to complete the memory request. In some examples, the memory controller includes a lookup table correlating key indexes to keys.

In some examples, a portion of the physical address is reserved for the key index. In some examples, the reserved portion of the physical address corresponds to upper bits of the physical address. In some examples, the reserved portion of the physical address is unused for address values.

In some examples, the memory request includes a guest identifier corresponding to a source of the memory request. In some examples, the control circuit is configured to select the key index based on the guest identifier. In some examples, the memory request includes an encryption indicator for indicating that the physical address is encrypted.

In one implementation, a system for guest private pages for confidential computing with GPU memory includes a memory, a processor, and a graphics processing unit (GPU). The GPU includes a graphics processing unit memory, a memory controller for the graphics processing unit memory, and a control circuit configured to (i) select a key index in response to a memory request including a physical address, wherein the physical address corresponds to a location of the graphics processing unit memory that is encrypted, (ii) insert the selected key index into a portion of the physical address that is reserved for the key index, and (iii) forward the physical address with the selected key index to the memory controller for completing the memory request.

In some examples, the memory controller is configured to identify a key using the key index, and perform an encryption operation on the physical address using the key to complete the memory request. In some examples, the memory controller includes a lookup table correlating key indexes to keys.

In some examples, the reserved portion of the physical address corresponds to upper bits of the physical address. In some examples, the reserved portion of the physical address is unused for address values.

In some examples, the memory request includes a guest identifier corresponding to a source of the memory request. In some examples, the control circuit is configured to select the key index based on the guest identifier. In some examples, the memory request includes an encryption indicator for indicating that the physical address is encrypted.

In one implementation, a method for guest private pages for confidential computing with GPU memory includes (i) selecting a key index by a control circuit in response to a memory request including a physical address, wherein the physical address corresponds to a location of a graphics processing unit memory that is encrypted, (ii) inserting, by the control circuit, the key index into a portion of the physical address that is reserved for the key index, (iii) identifying, by a memory controller of the graphics processing unit, a key using the key index, and (iv) performing, by the memory controller, an encryption operation on the physical address using the key to complete the memory request.

In some examples, the method further includes selecting the key index based on a guest identifier corresponding to a source of the memory request. In some examples, the method further includes identifying the key using a lookup table correlating key indexes to keys.

Features from any of the implementations described herein can be used in combination with one another in accordance with the general principles described herein. These and other implementations, features, and advantages will be more fully understood upon reading the following detailed description in conjunction with the accompanying drawings and claims.

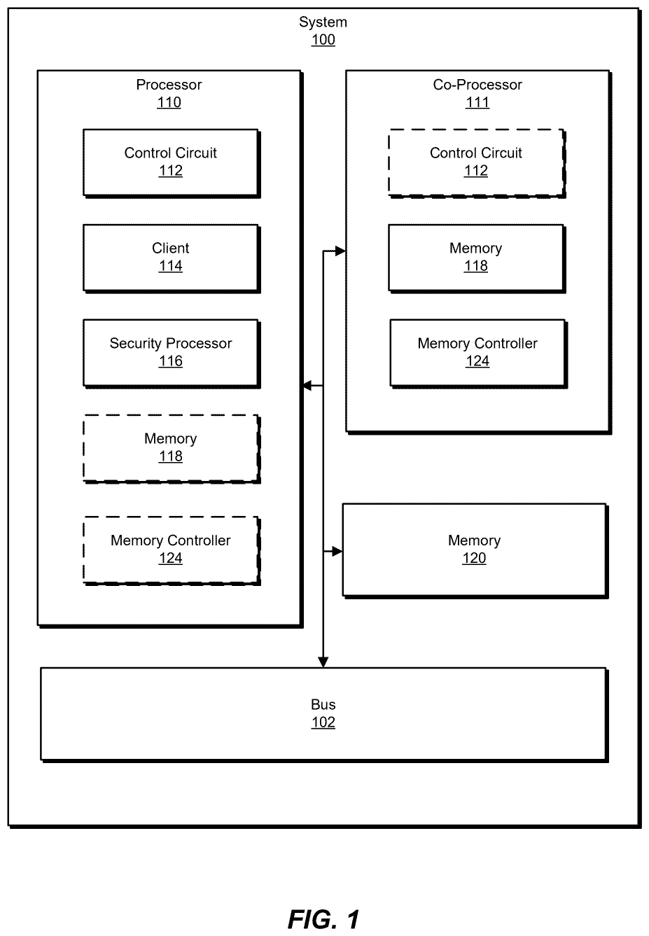

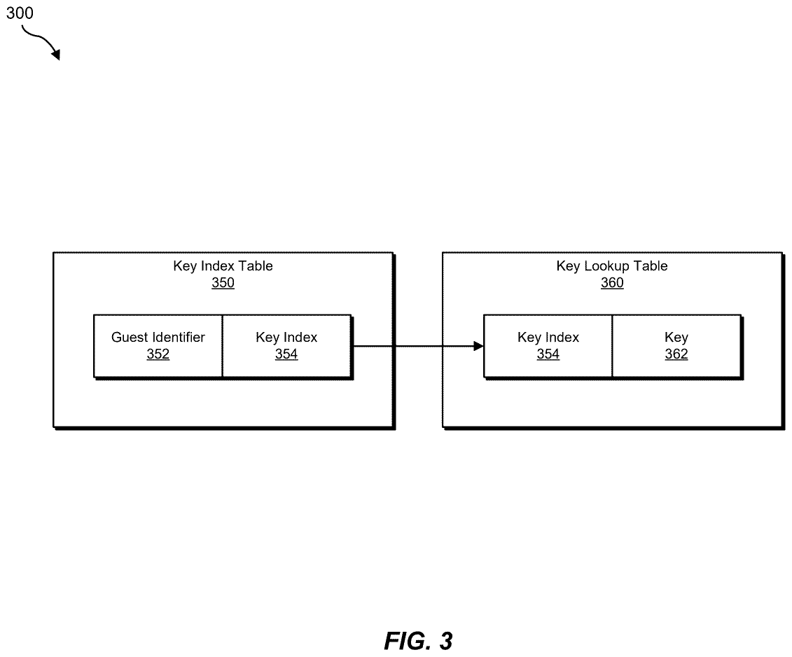

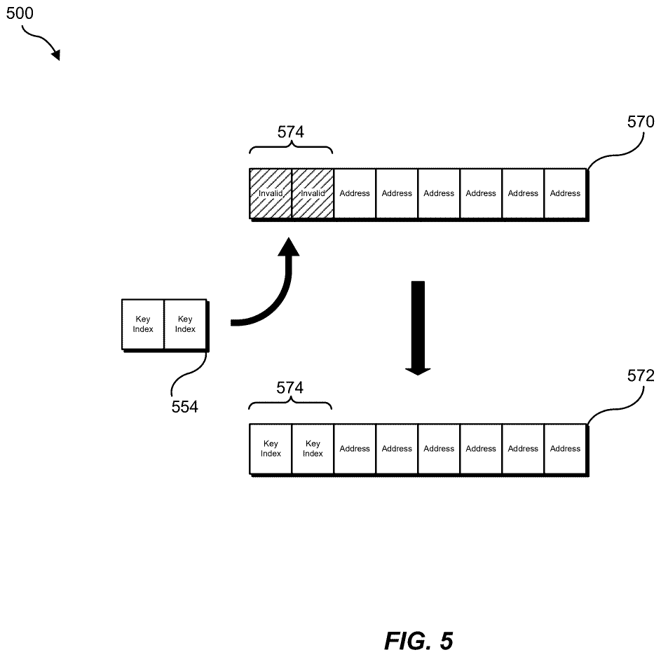

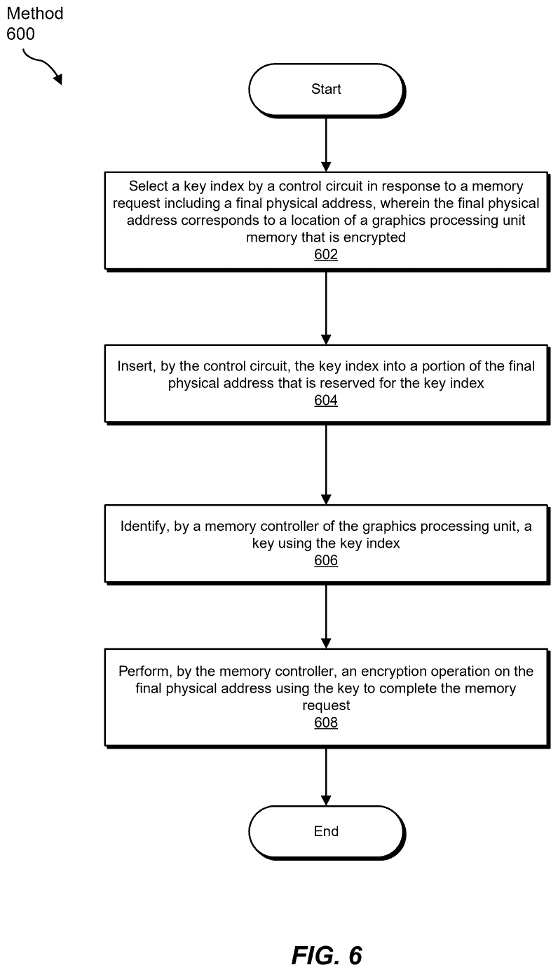

The following will provide, with reference to FIGS. 1-6, detailed descriptions of guest private pages for confidential computing using GPU memory. Detailed descriptions of example circuits and systems will be provided in connection with FIGS. 1 2 and 4. Detailed descriptions of example tables for managing keys will be provided in connection with FIG. 3. Detailed descriptions of example addresses and key indexes will be provided in connection with FIG. 5. Detailed descriptions of corresponding computer-implemented methods will also be provided in connection with FIG. 6.

FIG. 1 is a block diagram of an example system 100 for implementing guest private pages for confidential computing. System 100 corresponds to a computing device, such as a desktop computer, a laptop computer, a server, a tablet device, a mobile device, a smartphone, a wearable device, an augmented reality device, a virtual reality device, a network device, and/or an electronic device. As illustrated in FIG. 1, system 100 includes one or more memory devices, such as memory 120. Memory 120 generally represents any type or form of volatile or non-volatile storage device or medium capable of storing data and/or computer-readable instructions. Examples of memory 120 include, without limitation, Random Access Memory (RAM), Read Only Memory (ROM), flash memory, Hard Disk Drives (HDDs), Solid-State Drives (SSDs), optical disk drives, caches, variations, or combinations of one or more of the same, and/or any other suitable storage memory.

As illustrated in FIG. 1, example system 100 includes one or more physical processors, such as processor 110, which can correspond to one or more processors (e.g., a host processor along with a co-processor, which in some examples can be separate processors). Processor 110 generally represents any type or form of hardware-implemented processing unit capable of interpreting and/or executing computer-readable instructions. In some examples, processor 110 accesses and/or modifies data and/or instructions stored in memory 120. Examples of processor 110 include, without limitation, one or more instances of chiplets (e.g., smaller and in some examples more specialized processing units that can coordinate as a single chip), microprocessors, microcontrollers, Central Processing Units (CPUs), Field-Programmable Gate Arrays (FPGAs) that implement softcore processors, Application-Specific Integrated Circuits (ASICs), systems on chip (SoCs), digital signal processors (DSPs), Neural Network Engines (NNEs), accelerators, accelerated processing units (APUs), neural processing units (NPUs), tensor processing units (TPUs), other highly parallel processor units (PPUs), portions of one or more of the same, variations or combinations of one or more of the same (e.g., a host processor and a co-processor), and/or any other suitable physical processor(s). Further, in some examples, processor 110 can be a general-purpose processor that can be capable, without significant limitation, of various computing tasks, as opposed to a special purpose processor that can be limited in computing tasks (e.g., specially designed for particular computing tasks such as moving data, performing certain mathematical operations, etc.), although in other examples processor 110 can correspond to and/or incorporate one or more special purpose processors.

As also illustrated in FIG. 1, example system 100 can in some implementations optionally include one or more physical co-processors, such as co-processor 111, which in other implementations can be integrated with or otherwise represented by processor 110. Co-processor 111 generally represents any type or form of hardware-implemented processing unit capable of interpreting and/or executing computer-readable instructions, which in some examples works in conjunction and/or based on instructions from a host/main processor such as a CPU (e.g., processor 110). In some examples, co-processor 111 accesses and/or modifies data and/or instructions stored in memory 120. Examples of co-processor 111 include, without limitation, chiplets (e.g., smaller and in some examples more specialized processing units that can coordinate as a single chip), microprocessors, microcontrollers, graphics processing units (GPUs), Field-Programmable Gate Arrays (FPGAs) that implement softcore processors, Application-Specific Integrated Circuits (ASICs), systems on chip (SoCs), digital signal processors (DSPs), Neural Network Engines (NNEs), accelerators, accelerated processing units (APUs), neural processing units (NPUs), tensor processing units (TPUs), other highly parallel processor units (PPUs), portions of one or more of the same, variations or combinations of one or more of the same, and/or any other suitable physical processor.

FIG. 1 also includes a bus 102 that can correspond to any bus, circuitry, connections, and/or any other communicative pathways for sending communicative signals, based on one or more communication protocols, between components/devices (e.g., processor 110, memory 120, and/or co-processor 111, etc.). In some implementations, bus 102 can further connect, via wireless and/or wired connections, to other devices, such as peripheral devices external to or partially integrated with system 100. Although not illustrated in FIG. 1, in some implementations, system 100 can be coupled to a display device (e.g., via bus 102).

As further illustrated in FIG. 1, processor 110 and/or co-processor 111 includes a control circuit 112, a client 114, a security processor 116, a memory 118, and a memory controller 124. Control circuit 112 corresponds to circuitry and/or instructions for implementing confidential computing ownership checks, which can correspond to, interface with, and/or be integrated with various controllers, such as a memory controller, a security processor (e.g., security processor 116), etc. Client 114 corresponds to a processing component/unit, although in some examples can also generally represent any processing component (e.g., outside of processor 110) and/or interface or controller for processing components used for confidential computing. Security processor 116 corresponds to a processing component that can be used for monitoring and maintaining a security environment, such as preventing firmware attacks, managing boot processes, monitoring for unusual changes to processor/instruction pipelines and data stored in memory, encryption/decryption, etc. Memory 118 corresponds to another memory or storage device (as described herein), which can be physically separate from memory 120. Memory controller 124 can correspond to a memory controller (e.g., a control circuit for accessing memory) of memory 118. In some implementations, co-processor 111 can represent a GPU and memory 118 can represent a GPU memory thereof. In addition, although the examples described herein refer to a GPU and GPU memory, in other examples the GPU and GPU memory can correspond to an accelerator or other hardware.

In some examples, system 100 can provide confidential computing to guests (e.g., VMs) for protecting data stored in memory 120. For example, a controller (e.g., control circuit 112, security processor 116, and/or other controller for memory 120) can restrict access to guest data in memory 120 to only the guest owning the guest data, such that a hypervisor managing the guest and other guests are prevented from accessing the guest data. The systems and methods described herein allow extending similar confidential computing protections to guest data stored in memory 118.

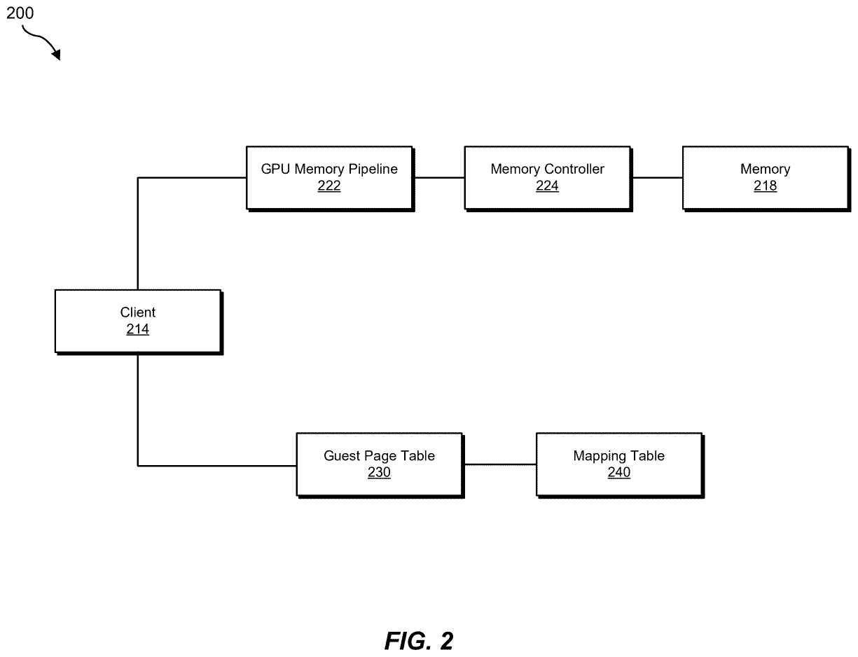

FIG. 2 illustrates a system 200 corresponding to system 100 and in some examples further corresponds to a basic memory request architecture with respect to a client 214 that corresponds to client 114. A top half of FIG. 2, including a GPU memory pipeline 222 (e.g., generally corresponding to a series of one or more processing components outputting to a next component), a memory controller 224 (e.g., a control circuit for accessing memory and in some examples corresponding to memory controller 124), and a memory 218 (e.g., a GPU memory and in some examples corresponding to memory 118), can correspond to a memory request flow, in some examples. A bottom half of FIG. 2, including a guest page table 230 (e.g., generally representing one or more structures such as page tables for translating or looking up a virtual address to a guest physical address) and a mapping table (e.g., generally representing one or more structures for translating or looking up a guest physical address to a final physical address), can correspond to a translation request flow, in some examples, as will be described further below. Although FIG. 2 illustrates a general architecture for confidential computing extended to GPU hardware, in some implementations, other architectures can be used.

Similar to system 100, system 200 can have a hypervisor and various guests running (e.g., via client 214 generally representing a hardware interface for memory operations for the guests and hypervisor), with one or more of the guests having confidential data requiring strict isolation (e.g., via encryption) from other guests or the hypervisor from accessing (e.g., reading, writing, copying, etc.). Each guest can be associated with a unique guest identifier which a control circuit (e.g., control circuit 112, security processor 116, and/or other controller) can use to distinguish between guests as well as the hypervisor.

A guest can operate in its own memory space (e.g., range of memory addresses) which the hypervisor can, in part, manage, such as by establishing which guest memory addresses map to which physical addresses of memory devices. For example, when a guest requests memory, the hypervisor can establish, using guest page table 230, a mapping from guest (or virtual) addresses to guest physical addresses (e.g., addresses corresponding to virtualized hardware for the guest). The hypervisor and/or control circuit can further establish, using mapping table 240, a mapping from guest physical addresses to (final) physical addresses that correspond to memory 218.

A memory request from client 214 can include a guest virtual address that can first be translated using guest page table 230 and mapping table 240 a to a final physical address. In some examples, this translation phase can include ownership checks for confirming whether a guest (indicated by a guest identifier with the initial memory request) owns the requested address (e.g., that the guest page is a valid private page and that the guest identifier is associated with the guest page). The guest page can be private and protected by encrypting the page in memory (e.g., memory 218). In other words, the physical address can correspond to a location of memory 218 that is encrypted. The control circuit and/or memory controller 224 can manage various keys for encryption using one or more tables. FIG. 3 illustrates an example of such tables.

FIG. 3 illustrates a system 300 corresponding to system 100 and/or a portion thereof, that includes a key index table 350 and a key lookup table 360. Key index table 350 includes, in FIG. 3, an example entry containing a guest identifier 352 and a key index 354. Key lookup table 360 includes, in FIG. 3, an example entry containing key index 354 and a key 362. For illustrative purposes, key index table 350 and key lookup table 360 each include a single entry. However, in other examples, each table can include multiple different entries as well as multiple different tables and/or levels of tables as needed.

Key index table 350 corresponds to one or more tables for managing which guests are assigned to which encryption keys. Guest identifier 352 can correspond to a unique identifier for distinguishing between guests and/or hypervisors. Key index 354 can correspond to an index or other identifier for identifying a key in key lookup table 360. Key lookup table 360 corresponds to one or more tables for managing multiple encryption keys. In some examples, the guest can request a guest private page (e.g., a private encrypted memory such as a page that only the guest can access, which is also private to the hypervisor). The hypervisor can provide a new page or convert a page assigned to the guest to the requested private page. In addition, if a corresponding guest identifier is not already available in key index table 350 and corresponding key is not available in key lookup table 360, the hypervisor and/or control circuit can establish new entries as needed. In some examples, key lookup table 360 can include various keys and key indexes which are not associated with any guest identifier in key index table 350 such that when the guest newly requests a private page, the guest identifier can be assigned, in key index table 350, to an available key index of key lookup table 360. In some examples, the hypervisor and/or control circuit can add a new guest identifier entry to key index table 350 and the control circuit (and/or security processor 116) can generate a new key to be associated with the key index in key lookup table 360.

Returning to FIG. 2, when a guest accesses memory or otherwise performs a memory operation (e.g., via client 214), the request can include a guest identifier (e.g., guest identifier 352) and a virtual address, which can undergo an address translation phase to determine a (final) physical address for a memory request phase. During the translation phase, the control circuit can return an encryption indicator that indicates that the physical address is encrypted. In some examples, the translation phase can include validating the guest identifier as properly owning the requested page/address, resulting in a corresponding encryption indicator.

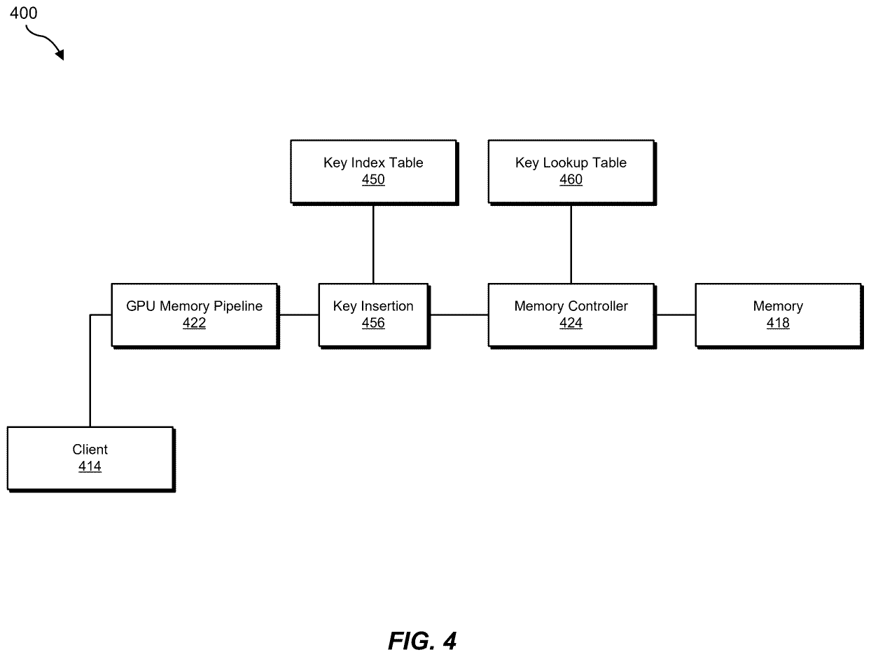

In some examples, the physical address and guest identifier and/or encryption indicator can be forwarded to a memory request phase. FIG. 4 illustrates an example memory request phase pipeline of a system 400 corresponding to system 100. System 400 includes a GPU memory pipeline 422 corresponding to GPU memory pipeline 222, a key insertion circuit 456 (which in some examples can correspond to or otherwise interface with control circuit 112), a key index table 450 corresponding to key index table 350, a memory controller 424 corresponding to memory controller 124, a key lookup table 460 corresponding to key lookup table 360, and a memory 418 corresponding to memory 218.

In FIG. 4, client 414 can forward previously-translated physical address along GPU memory pipeline 422. In some examples, client 414 can also forward or otherwise make available a guest identifier (e.g., guest identifier 352) corresponding to a source of the memory request, and an encryption indicator that indicates whether the physical address is encrypted.

If the encryption indicator indicates that the physical address of the memory request is encrypted, key insertion circuit 456 can select a key index (e.g., key index 354) that matches with the guest identifier (e.g., guest identifier 352 as shown in FIG. 3). Key insertion circuit 456 can forward the selected key index with the physical address to memory controller 424 for completing the memory request. In other examples, if the encryption indicator does not indicate that the physical address is encrypted, key insertion circuit 456 can forward the physical address to memory controller 424 without a key index.

In some implementations, key insertion circuit 456 can forward the selected key index by inserting the key index into the physical address, as further illustrated in FIG. 5. FIG. 5 illustrates a diagram 500 of a physical address 570, a key index 554 corresponding to key index 354, and an updated physical address 572.

As illustrated in FIG. 5, updated physical address 572 can correspond to a bit sequence in accordance with an addressing scheme. Although FIG. 5 illustrates 8 bits for discussion purposes, in other examples, addresses can include greater or fewer bits. In FIG. 5, an address can include 6 bits for an address value, and a reserved portion 574 (e.g., 2 bits in FIG. 5) that is reserved for a key index and not used for the address value. Reserved portion 574 can correspond to invalid data (e.g., undefined bit values or otherwise ignored values) although in other examples, reserved portion 574 can include data, status bits, etc., that can be used until being overwritten with a key index. For instance, reserved portion 574 can include indicators (e.g., a guest identifier and/or an encryption indicator) that can be useful for selecting a key index, and no longer necessary once the appropriate key index is selected. Moreover, as illustrated in FIG. 5, reserved portion 574 can correspond to upper address bits, although in other examples other bit ranges can be used.

Based on the encryption indicator (indicating a key is needed for the memory operation) and the guest identifier (relating to the key that is needed), key insertion circuit 456 can select key index 554 which has a bit width corresponding to that of reserved portion 574. Key insertion circuit 456 can insert (e.g., writing bit values of) key index 554 into reserved portion 574, producing updated physical address 572 that includes the address value and key index value. Although the key index values can be separate from the address values, in some implementations, an addressing scheme can further incorporate key index values.

Turning back to FIG. 4, key insertion circuit 456 can forward the selected key index (e.g., key index 554) and the physical address (e.g., physical address 570) to memory controller 424 by forwarding updated physical address 572. Memory controller 424 can include or otherwise interface with key lookup table 460 to find a correct key based on the key index (e.g., key 362 based on key index 354 in FIG. 3). In some examples, memory controller 424 can read from reserved portion 574 of updated physical address 572. If memory controller 424 finds a valid key index (e.g., as referenced in key lookup table 460), memory controller 424 can accordingly find key 362 in key lookup table 460. In other examples, memory controller 424 can incorporate key lookup table 460 in reading the address value from updated physical address 572 to retrieve or otherwise access key 362. In some examples, if the key index does not reference a valid key or is otherwise absent from key lookup table 460, memory controller 424 can issue a fault or other error message.

Using key 362, memory controller 424 can perform an encryption operation at the memory location of memory 418 corresponding to the physical address to complete the memory request. In some examples, the encryption operation can correspond to an encryption process of encrypting data to be stored at the location, in accordance with the memory operation. In other examples, the encryption operation can correspond to a decryption process of decrypting data stored at the location and returned in accordance with the memory operation.

In some examples, memory controller 424 can further track which locations of memory 418 are encrypted such that memory controller 424 can read the physical address, and if the location corresponds to an encrypted location, memory controller 424 can extract the key index. If the key index and/or key (in key lookup table 460) are unavailable, memory controller 424 can issue a fault. Alternatively, if the location is not encrypted, memory controller 424 can ignore any key index values or can issue a fault if a key index was provided. Further, if the guest relinquishes the private page, memory controller 424, the control circuit, and/or the hypervisor can clear out entries as needed. For example, memory controller 424 can designate the corresponding locations in memory 418 as not encrypted and invalidate related entries in key lookup table 460, and the control circuit can invalidate related entries in key index table 450.

FIG. 6 is a flow diagram of an exemplary computer-implemented method 600 for private guest pages for confidential computing using GPU memory. The steps shown in FIG. 6 can be performed by any suitable computer-executable code and/or computing system, including the system(s) illustrated in FIGS. 1, 2, and/or 4. In one example, each of the steps shown in FIG. 6 represent an algorithm whose structure includes and/or is represented by multiple sub-steps, examples of which will be provided in greater detail below.

As illustrated in FIG. 6, at step 602 one or more of the systems described herein select a key index by a control circuit in response to a memory request including a physical address. The physical address can correspond to a location of a graphics processing unit memory that is encrypted. For example, control circuit 112 can select a key index (e.g., key index 354) in response to a memory request including a physical address (e.g., physical address 570) corresponding to an encrypted location of memory 118.

The systems described herein can perform step 602 in a variety of ways. In some examples, control circuit 112 can select the key index based on a guest identifier (e.g., guest identifier 352) corresponding to a source of the memory request.

At step 604 one or more of the systems described herein insert, by the control circuit, the key index into a portion of the physical address that is reserved for the key index. For examples, control circuit 112 can insert the selected key index (e.g., key index 554) into a portion (e.g., reserved portion 574) of the physical address.

At step 606 one or more of the systems described herein identify, by a memory controller of the graphics processing unit, a key using the key index. For example, memory controller 124 can identify a key (e.g., key 362) using the key index.

The systems described herein can perform step 606 in a variety of ways. In some examples, memory controller 124 can identify the key using a lookup table (e.g., key lookup table 360) correlating key indexes to keys.

At step 608 one or more of the systems described herein perform, by the memory controller, an encryption operation on the physical address using the key to complete the memory request. For example, memory controller 124 can perform an encryption operation using the key to complete the memory request.

As detailed above, guest VMs can enable confidential computing workloads on the GPUs, if their sensitive data can be kept both integrity-protected and confidential. In order to meet those requirements, a GPU, as described herein, can support several features in the translation and memory datapaths.

In the memory datapath, when a client (e.g., a graphics engine) issues a request with a request for a new encrypted page, the controllers described herein can repurpose tops bits of a physical address and insert a key_index, based on the guest VM's ID (e.g., guest identifier 352). The key_index can be used to select an actual 128b/256b (or other encryption scheme) key to do encryption in the memory controller itself such that the key is not exposed outside of the memory controller.

As detailed above, the circuits, devices, and systems described and/or illustrated herein broadly represent any type or form of computing device or system capable of executing computer-readable instructions. In their most basic configuration, these computing device(s) each include at least one memory device and at least one physical processor.

In some examples, the term “memory device” generally refers to any type or form of volatile or non-volatile storage device or medium capable of storing data and/or computer-readable instructions. In one example, a memory device stores, loads, and/or maintains one or more of the modules and/or circuits described herein. Examples of memory devices include, without limitation, Random Access Memory (RAM), Read Only Memory (ROM), flash memory, Hard Disk Drives (HDDs), Solid-State Drives (SSDs), optical disk drives, caches, variations, or combinations of one or more of the same, or any other suitable storage memory.

In some examples, the term “physical processor” generally refers to any type or form of hardware-implemented processing unit capable of interpreting and/or executing computer-readable instructions. In one example, a physical processor accesses and/or modifies one or more modules stored in the above-described memory device. Examples of physical processors include, without limitation, microprocessors, microcontrollers, Central Processing Units (CPUs), Field-Programmable Gate Arrays (FPGAs) that implement softcore processors, Application-Specific Integrated Circuits (ASICs), systems on a chip (SoCs), digital signal processors (DSPs), Neural Network Engines (NNEs), accelerators, graphics processing units (GPUs), portions of one or more of the same, variations or combinations of one or more of the same, or any other suitable physical processor.

In some implementations, the term “computer-readable medium” generally refers to any form of device, carrier, or medium capable of storing or carrying computer-readable instructions. Examples of computer-readable media include, without limitation, transmission-type media, such as carrier waves, and non-transitory-type media, such as magnetic-storage media (e.g., hard disk drives, tape drives, and floppy disks), optical-storage media (e.g., Compact Disks (CDs), Digital Video Disks (DVDs), and BLU-RAY disks), electronic-storage media (e.g., solid-state drives and flash media), and other distribution systems.

The process parameters and sequence of the steps described and/or illustrated herein are given by way of example only and can be varied as desired. For example, while the steps illustrated and/or described herein are shown or discussed in a particular order, these steps do not necessarily need to be performed in the order illustrated or discussed. The various exemplary methods described and/or illustrated herein can also omit one or more of the steps described or illustrated herein or include additional steps in addition to those disclosed.

The preceding description has been provided to enable others skilled in the art to best utilize various aspects of the exemplary implementations disclosed herein. This exemplary description is not intended to be exhaustive or to be limited to any precise form disclosed. Many modifications and variations are possible without departing from the spirit and scope of the present disclosure. The implementations disclosed herein should be considered in all respects illustrative and not restrictive. Reference should be made to the appended claims and their equivalents in determining the scope of the present disclosure.

Unless otherwise noted, the terms “connected to” and “coupled to” (and their derivatives), as used in the specification and claims, are to be construed as permitting both direct and indirect (i.e., via other elements or components) connection. In addition, the terms “a” or “an,” as used in the specification and claims, are to be construed as meaning “at least one of.” Finally, for ease of use, the terms “including” and “having” (and their derivatives), as used in the specification and claims, are interchangeable with and have the same meaning as the word “comprising.”

What is claimed is:

1. A device comprising:
a control circuit configured to:
select a key index in response to a memory request including a final physical address, wherein the physical address corresponds to a location of a graphics processing unit memory that is encrypted; and
forward the selected key index with the physical address to a memory controller of the graphics processing unit memory for completing the memory request.

2. The device of claim 1, wherein the memory controller is configured to:
identify a key using the key index; and
perform an encryption operation on the physical address using the key to complete the memory request.

3. The device of claim 2, wherein the memory controller includes a lookup table correlating key indexes to keys.

4. The device of claim 1, wherein a portion of the physical address is reserved for the key index.

5. The device of claim 4, wherein the reserved portion of the physical address corresponds to upper bits of the physical address.

6. The device of claim 4, wherein the reserved portion of the physical address is unused for address values.

7. The device of claim 1, wherein the memory request includes a guest identifier corresponding to a source of the memory request.

8. The device of claim 7, wherein the control circuit is configured to select the key index based on the guest identifier.

9. The device of claim 1, wherein the memory request includes an encryption indicator for indicating that the physical address is encrypted.

10. A system comprising:
a memory;
a processor; and
a graphics processing unit comprising:
a graphics processing unit memory;
a memory controller for the graphics processing unit memory; and
a control circuit configured to:
select a key index in response to a memory request including a physical address, wherein the physical address corresponds to a location of the graphics processing unit memory that is encrypted;
insert the selected key index into a portion of the physical address that is reserved for the key index; and
forward the physical address with the selected key index to the memory controller for completing the memory request.

11. The system of claim 10, wherein the memory controller is configured to:
identify a key using the key index; and
perform an encryption operation on the physical address using the key to complete the memory request.

12. The system of claim 11, wherein the memory controller includes a lookup table correlating key indexes to keys.

13. The system of claim 10, wherein the reserved portion of the physical address corresponds to upper bits of the physical address.

14. The system of claim 10, wherein the reserved portion of the physical address is unused for address values.

15. The system of claim 10, wherein the memory request includes a guest identifier corresponding to a source of the memory request.

16. The system of claim 15, wherein the control circuit is configured to select the key index based on the guest identifier.

17. The system of claim 10, wherein the memory request includes an encryption indicator for indicating that the physical address is encrypted.

18. A method comprising:
selecting a key index by a control circuit in response to a memory request including a physical address, wherein the physical address corresponds to a location of a graphics processing unit memory that is encrypted;
inserting, by the control circuit, the key index into a portion of the physical address that is reserved for the key index;
identifying, by a memory controller of the graphics processing unit, a key using the key index; and
performing, by the memory controller, an encryption operation on the physical address using the key to complete the memory request.

19. The method of claim 18, further comprising selecting the key index based on a guest identifier corresponding to a source of the memory request.

20. The method of claim 18, further comprising identifying the key using a lookup table correlating key indexes to keys.
